(19) United States
(12) Patent Application Publication
(10) Pub. No.: US 2026/0054962 A1
(43) Pub. Date: Feb. 26, 2026

(54) ELEVATOR SYSTEM HAVING A PLATFORM ON TOP OF OR BELOW THE CAR

(71) Applicant: Otis Elevator Company, Farmington, CT (US)

(72) Inventor: Gerard Sirigu, Gien (FR)

(21) Appl. No.: 19/310,366

(22) Filed: Aug. 26, 2025

(30) Foreign Application Priority Data
Aug. 26, 2024 (EP) 24306398.9

(51) Int. Cl. B66B 5/00

(52) U.S. Cl. CPC B66B 5/0062

(57) ABSTRACT

An elevator system (1) to be positioned in a hoistway (2). The elevator system includes an elevator car (3), at least one guide rail (4) for guiding the elevator car when moving up and down in the hoistway, and a security device (5) that is designed and arranged in such way that a safety volume (6) above or below the elevator car inside the hoistway can be set in at least one secured state for safe maintenance operation of a mechanic inside the safety volume. The security device comprises at least one first blocking device (7) attached to the at least one guide rail or configured for being mounted to a wall of the hoistway and at least one second blocking device (8) configured to be mounted on or in the elevator car to cooperate with the first blocking device.

### FOREIGN PRIORITY

This application claims priority to European Patent Application No. 24306398.9, filed Aug. 26, 2024, and all the benefits accruing therefrom under 35 U.S.C. § 119, the contents of which in its entirety are herein incorporated by reference.

### TECHNICAL FIELD OF INVENTION

The disclosure relates to a counterweight for an elevator system having an elevator car and at least one guide rail for guiding the elevator car when moving up and down in the hoistway.

### BACKGROUND OF THE INVENTION

It is well known that elevator systems have to be maintained, however, this often requires additional space in the hoistway for elevators so that the mechanics have sufficient space to service the components located above or below the car. At the same time, the car should be reliably held in a certain waiting position.

In this respect, it is an object of the present disclosure to provide an improved elevator system where the known disadvantages of the prior art are avoided.

This is solved by an elevator system according to the independent claim. Alternative embodiments are subject matter of the dependent claims.

### SUMMARY OF THE INVENTION

According to an aspect, an elevator system to be positioned in a hoistway is provided. The elevator system comprises an elevator car, at least one guide rail for guiding the elevator car when moving up and down in the hoistway, and a security device that is designed and arranged in such way that a safety volume above or below the elevator car inside the hoistway can be set in at least one secured state for safe maintenance operation of a mechanic inside the safety volume. The term “safety volume” used in this context is basically to be understood as a volume that is large enough for the mechanic to enter and carry out the necessary maintenance work. In particular, the safety volume can have a height of at least 1 meter. The security device comprises at least one first blocking device attached to the at least one guide rail or configured for being mounted to a wall of the hoistway and at least one second blocking device configured to be mounted on or in the elevator car from within the elevator car to interact with the first blocking device to prevent upward movement of the elevator car when the safety volume is arranged above the elevator car or downward movement of the elevator car when the safety volume is arranged below the elevator car. This configuration maintains safe and easy conditions for the field technicians performing the maintenance on or under the car. It also maintains safe conditions for passengers when the lift is running in normal operation. A safety volume is provided while the technician is performing maintenance from inside the car. It safely allows car movement while field technicians perform maintenance tasks. This configuration addresses low overhead and low pit configurations.

According to an aspect, the first blocking device is wedge-shaped, stick-shaped or plate-shaped. The first blocking device may be provided as a steel angle (having a triangular shape). The first blocking device thus may have at least an extension transversal to a longitudinal extension of the at least one guide rail. The first blocking device is therefore simple in design and robust at the same time.

According to an aspect, the first blocking device is configured as a fixed stop in a certain position along the at least one guide rail. This makes it as easy as possible to control the secured state.

According to an aspect, two guide rails are provided and on each guide rail one first blocking device is attached. By creating two support points, the car is supported in the secured state more stable.

According to an aspect, the second blocking device is wedge-shaped, stick-shaped or plate-shaped. This also makes the second blocking device easy to manufacture.

According to an aspect, the second blocking device comprises a holding rod for being anchored to the elevator car in the secured state. This simplifies the installation of the second blocking device in the car.

According to an aspect, the second blocking device comprises a support area that is wider than the holding rod and is arranged outside the elevator car for direct contact with the first blocking device in the secured state.

According to an aspect, the at least one second blocking device is sliding guided in the elevator car. The at least one second blocking device can be sliding guided at least indirectly relative to a frame or the cabin of the elevator car. Thus, the second blocking device can be safely adjusted.

According to an aspect, the at least one second blocking device is accommodated in or under a floor plate of the elevator car. Alternatively the at least one second blocking device can be integrated in a ceiling or a sidewall of the elevator car. This does not adversely affect the interior of the car.

According to an aspect, two second blocking devices are provided and designed as identical parts. This simplifies handling and assembly.

According to an aspect, the two second blocking devices when seen along their longitudinal direction are fixed at the same longitudinal position on the elevator car. This also simplifies handling and assembly.

According to an aspect, the at least one first blocking device and the at least one second blocking device are matched together such as to create a fixed stop and/or a form fit at least in the upward direction of the elevator car when the safety volume is arranged above the elevator car or in the downward direction of the elevator car when the safety volume is arranged below the elevator car.

According to an aspect, two second blocking devices are provided and configured to stick out of the elevator car in opposite directions of the elevator car. This also simplifies handling and assembly.

According to an aspect, a side wall of the elevator car has an opening through which the second blocking device can be inserted from an inside to an outside of the elevator car. Again, this simplifies handling and assembly from inside the car.

According to an aspect, a flap/plinth attached to the elevator car is provided that can close the opening.

In other words, a standard cabin (elevator car) is provided on which removable decorative plinths can be installed. A blocking tool (security device) comprises wedges (second blocking device) which are provided and once installed and locked in the cabin, will prevent it from moving beyond a certain altitude. Two steel angles (first blocking devices) mounted on the guides (guide rails) or fixed to the hoistway wall can block the cabin in upper inspection position (secured state). A cabin roof access detection system can be provided which will block any movement of the cabin if the tool below is not installed. Furthermore, a contact can be included which monitors the position of the tools. A trap roof can be provided to access to the top of car from the cabin. Also, a moveable barrier on top of the car can be provided.

### BRIEF DESCRIPTION OF THE DRAWINGS

Embodiments of the present disclosure, as an example only, will be described in the following with reference to the drawings. In the drawings:

FIG. 1 shows a side view of a simplified illustrated elevator system including an elevator car, guide rails and a security device for defining and holding a safety volume above the elevator car inside a hoistway in at least one secured state for safe maintenance operation of a mechanic inside the safety volume;

FIG. 2 shows a perspective view of two blocking devices (hereinafter referred to as second blocking devices) as used in FIG. 1 that are intended for being fixed to the elevator car;

FIG. 3 shows a side view of the elevator car as used in FIG. 1 showing several flaps provided in and on the car for maintenance operation; and

FIG. 4 shows a side view of a first blocking device next to a guide rail as used in FIG. 1, the first blocking device serving as a fixed stop for one of the second blocking devices in the secured state.

### DETAILED DESCRIPTION OF THE INVENTION

In the following, embodiments of the present disclosure are explained with reference to the drawings. The same elements are assigned with the same reference numbers in the drawings. It is to be noted, that the embodiments are described for exemplary purposes only and the description of the embodiments is not intended to limit the scope of the present disclosure.

FIG. 1 shows an elevator system 1 according to an exemplary embodiment. The elevator system 1 is arranged/inserted/mounted in a hoistway 2. The hoistway 2 can be confined by corresponding walls in a housing in the usual way. The elevator car 3 can be moved up and down in this hoistway 2 in the usual way.

At least one guide rail 4 is provided to guide the up and down movement of the elevator car 3. According to FIG. 1, also more than one, for example two guide rails 4 can be used. The respective guide rail 4 is attached (directly or indirectly) to the walls of the hoistway 2. The guide rails 4 again run in the usual way in their longitudinal direction along/parallel to the hoistway 2.

As also indicated in FIG. 1, it is often necessary to provide a safety volume 6 above the elevator car 3 (low overhead configuration) in case of maintenance work, in which safety volume 6, for example, components of the drive of the elevator car 3 are located and therefore a mechanic must be able to step in in a maintenance position of the elevator car 3. Alternatively, the safety volume 6 can also be provided below the elevator car 3, like in a low pit configuration.

In order to be able to set this safety volume 6 reliably in the same position at all times, thereby reducing the space required in the hoistway 2, but at the same time ensuring sufficient accessibility for the mechanic, a security device 5 is provided, which ensures that the elevator car 3 always comes to a standstill in the same fixed position in a secured state for safe maintenance operation of a mechanic inside the safety volume 6.

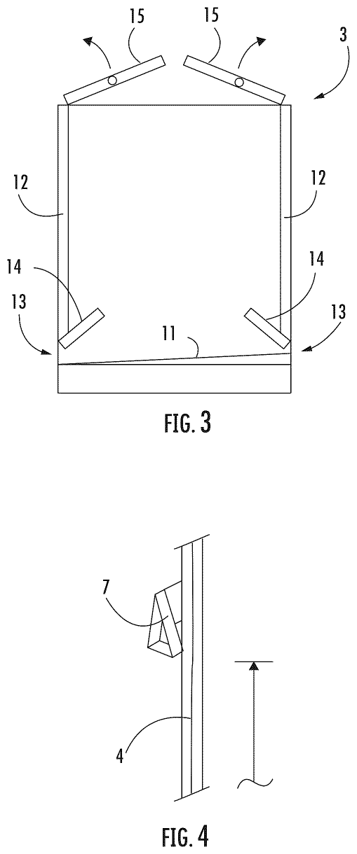

Looking at FIGS. 1 and 4 together, it can be seen that the security device 5 has at least a first blocking device 7. This first blocking device 7 is ultimately also firmly connected to a wall of the hoistway 2. For this purpose, the first blocking device 7 can be attached directly to the wall of the hoistway 2. Alternatively, the first blocking device 7 can also be indirectly connected to the wall of the hoistway 2 and, for example, be fixed to the guide rail 4, which in turn is connected to the wall.

It can also be seen that a plurality (e.g., two as shown in this example) of first blocking devices 7 can also be present. One first blocking device 7 is attached to or in the area of each guide rail 4. Both first blocking devices 7 can be arranged at the same height (seen along the hoistway 2/the guide rail 4) as shown in FIG. 1.

The respective first blocking device 7 is designed, for example, as a wedge-shaped/triangular stop element, but can in principle also have other shapes, such as a plate or a pin.

The respective first blocking device 7 can project beyond the respective guide rail 4 in the transverse direction of the respective guide rail 4 towards the elevator car 3 in order to ultimately interact in the secured state with a second blocking device 8 described in more detail below.

The respective first blocking device 7 can also be made of a steel material and thus be formed as a steel angle.

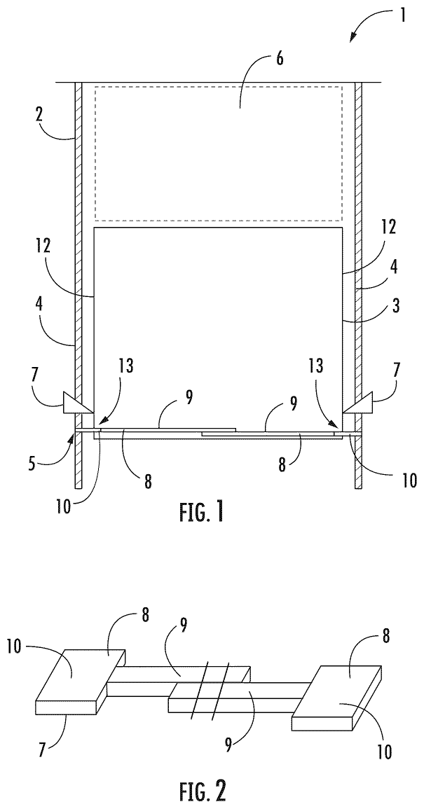

Looking at FIGS. 1 and 2 together, the second blocking devices 8 of the security device 5 are illustrated, each of which interacts with a first blocking device 7. Again, since each second blocking device 8 interacts with only one first blocking device 7, only one second blocking device 8 can alternatively be present instead of several, such as two second blocking devices 8 shown in FIGS. 1 and 2.

The respective second blocking device 8 is attached in or on the elevator car 3 during maintenance. The second blocking device 8 has a holding rod 9, which is firmly connected to the elevator car 3/to a frame or a cabin of the elevator car 3 in the secured state. The holding rod 9 is arranged in a floor, namely below a floor plate 11 forming this floor, which is therefore only accessible by the mechanic during maintenance. Alternatively, the second blocking device 8 (with its holding rod) can also be arranged in any other part of the elevator car 3, like a part of the frame (like the uprights) or of the cabin (like the side walls, the floor, the ceiling and associated panels).

The holding rod 9 also penetrates a side wall 12 of the elevator car 3 through an opening 13, for example in the form of a through hole. A section of the second blocking device 8 is therefore located outside the elevator car 3 and overlaps the associated first blocking device 7 in the transverse direction in the area of a support area 10. This support area 10 is used for direct contact with the first blocking device 7 in the secured state.

FIG. 2 shows that the support area 10 can be plate-shaped, for example. The support area 10 can therefore be wider than the holding rod 9.

Ultimately, in the exemplary embodiment of FIGS. 1 and 2, two second blocking devices 8 are thus provided, which project outwards from an interior of the elevator car 3 towards opposite sides/side walls of the elevator car 3. The two first blocking devices 7 can thus block the elevator car 3 in an upper inspection position (secured state) or alternatively in a lower inspection position.

It should also be noted that the at least one second blocking device 8 can remain permanently in the elevator car 3, i.e. even during normal operation of the elevator system 1. For this purpose, the second blocking device 8 can be guided in a displaceable manner between a position completely stowed inside the elevator car 3 and an extended position as shown in FIG. 1. In this configuration, the second blocking devices 8 are accessible and adjustable from inside the elevator car 3.

If two second blocking devices 8 are used, these can be attached to the elevator car 3 in their extended position in a common area, approximately at the same height as their partially overlapping holding rods 9, as symbolized by the corresponding lines in FIG. 2.

Finally, FIG. 3 indicates that decorative flaps 14, which can be pivotably attached to the side walls 12, can also be provided to close the openings 13. Of course, only the mechanic can open these flaps 14 (shown in FIG. 3 in the open position) in order to gain access to the openings 13 and to be able to attach the second blocking device 8 in the position shown in FIG. 1.

In the usual way, the elevator car 3 also has exit flaps 15 on its upper side (as trap roof) so that the mechanic can enter the safety volume 6 for servicing. Alternatively, these exit flaps 15 can be provided on a lower side of the elevator car 3.

In this regard, it should be noted that a cabin roof access detection system/cabin floor access detection system can be provided such that it will block any movement of the cabin if the second blocking device 8 is not installed in its extended position (according to FIG. 1).

Furthermore, also a contact can be included which monitors the position of the at least second blocking device 8.

Also, a moveable barrier on top of the car can be provided.

In the event of servicing, the security device 5 thus provides a fixed-position support of the elevator car 3 in the hoistway 2, determined by the stop of the at least one second blocking device 8 on the at least one first blocking device 7, in order to securely set the safety volume 6 and maintain it for the duration of the servicing work. In order to subsequently resume normal operation, the at least one second blocking device 8 is either completely removed from the elevator car 3 or at least retracted from its extended position overlapping the first blocking device 7 back into a position remote from the first blocking device 7, in which it does not overlap the first blocking device 7.

What is claimed is:

1. An elevator system (1) to be positioned in a hoistway (2), the elevator system (1) comprising:
an elevator car (3),
at least one guide rail (4) for guiding the elevator car (3) when moving up and down in the hoistway (2), and
a security device (5) that is designed and arranged in such way that a safety volume (6) above or below the elevator car (3) inside the hoistway (2) can be set in at least one secured state for safe maintenance operation of a mechanic inside the safety volume (6),
wherein the security device (3) comprises at least one first blocking device (7) attached to the at least one guide rail (4) or configured for being mounted to a wall of the hoistway (2) and at least one second blocking device (8) configured to be mounted on or in the elevator car (3) to interact with the first blocking device (7) to prevent upward movement of the elevator car (3) when the safety volume (6) is arranged above the elevator car (3) or downward movement of the elevator car (3) when the safety volume (6) is arranged below the elevator car (3).

2. The elevator system (1) according to claim 1, wherein the first blocking device (7) is wedge-shaped, stick-shaped or plate-shaped.

3. The elevator system (1) according to claim 1, wherein the first blocking device (7) is configured as a fixed stop in a certain position along the at least one guide rail (4).

4. The elevator system (1) according to claim 1, wherein two guide rails (4) are provided and that on each guide rail (4) one first blocking device (7) is attached.

5. The elevator system (1) according to claim 1, wherein the second blocking device (8) is wedge-shaped, stick-shaped or plate-shaped.

6. The elevator system (1) according to claim 1, wherein the second blocking device (8) comprises a holding rod (9) for being anchored to the elevator car (3) in the secured state.

7. The elevator system (1) according to claim 6, wherein the second blocking device comprises (8) a support area (10) that is wider than the holding rod (9) and is arranged outside the elevator car (3) for direct contact with the first blocking device (7) in the secured state.

8. The elevator system (1) according to claim 1, wherein the at least one second blocking device (8) is sliding guided in the elevator car (3).

9. The elevator system (1) according to claim 1, wherein the at least one second blocking device (8) is accommodated in or under a floor plate (11) of the elevator car (3).

10. The elevator system (1) according to claim 1, wherein two second blocking devices (8) are provided and designed as identical parts.

11. The elevator system (1) according to claim 10, wherein the two second blocking devices (8) when seen along their longitudinal direction are fixed at the same longitudinal position on the elevator car (3).

12. The elevator system (1) according to claim 1, wherein the at least one first blocking devices (7) and the at least one second blocking device (8) are matched together such as to create a fixed stop and/or a form fit at least in the upward direction of the elevator car (3) when the safety volume (6) is arranged above the elevator car (3) or in the downward direction of the elevator car (3) when the safety volume (6) is arranged below the elevator car (3).

13. The elevator system (1) according to claim 1, wherein two second blocking devices (8) are provided and configured to stick out of the elevator car (3) in opposite directions of the elevator car (3).

14. The elevator system (1) according to claim 1, wherein a side wall (12) of the elevator car (3) has an opening (13) through which the second blocking device (8) can be inserted from an inside to an outside of the elevator car (3).

15. The elevator system (1) according to claim 14, wherein a flap (14) attached to the elevator car (3) is provided that can close the opening (13).
